(19) United States
(12) Patent Application Publication
(10) Pub. No.: US 2025/0001916 A1
(43) Pub. Date: Jan. 2, 2025

(54) CHILD RESTRAINT SYSTEM

(71) Applicant: Graco Children's Products, Inc., Atlanta, GA (US)

(72) Inventors: Thomas Jake Mitchell, Smyrna, GA (US); Douglas Jin Kim, Marietta, GA (US); Adam Andrew McKenzie, Decatur, GA (US); Mark T. La Plante, Cumming, GA (US)

(21) Appl. No.: 18/674,199

(22) Filed: May 24, 2024

Related U.S. Application Data
(60) Provisional application No. 63/511,290, filed on Jun. 30, 2023.

(51) Int. Cl. B60N 2/28

(52) U.S. Cl. CPC B60N 2/2851

(57) ABSTRACT

A child restraint system is provided. The child restraint system may be used to secure a child within a vehicle. The child restraint system includes a headrest including a rear portion and one or more sidewalls. Each of the one or more sidewalls includes a first region and a second region. The first region is provided between the second region and the rear portion of the headrest. The first region includes material that protrudes from the sidewall at a greater distance than the material that is included in the second region. Additionally, a slope in the material is provided downwards from the first region into the second region. In this manner, the head of the child travels across the first region and downwards into the second region during a side crash event, which results in energy dissipation occurring over a greater distance.

### CROSS REFERENCE TO RELATED APPLICATIONS

This application is a continuation of and claims priority to, U.S. Provisional Application No. 63/511,290 filed Jun. 30, 2023, entitled “Child Restraint System,” the disclosure of which is incorporated herein by reference in its entirety.

### TECHNICAL BACKGROUND

The present disclosure is generally in the field of child restraint systems, and more particularly related to side impact for child restraint systems.

### BACKGROUND

New crash standards have been established in the United States for side crash events in vehicles. This introduces new challenges for energy management that occurs during a side crash event. This energy management may include mitigating the energy a passenger's head experiences during a side crash when the head and child restraint system come into contact with a door structure of the vehicle

### SUMMARY

In embodiments, the present disclosure describes a child restraint system comprising a seat and a headrest. The child restraint system also comprises a rear portion, a first sidewall, and a second sidewall. The headrest further comprises a first region protruding a first distance from the first sidewall and a second region protruding a second distance from the first sidewall, wherein the second distance is less than the first distance, wherein the first region is provided between the rear portion and the second region, and wherein a slope is formed between the first region and the second region, and wherein the slope transitions from the first region downward into the second region.

In embodiments, the present disclosure describes a headrest for a child restraint system. The headrest also comprises a rear portion, a first sidewall, and a second sidewall. The headrest further comprises a first region protruding a first distance from the first sidewall and a second region protruding a second distance from the first sidewall, wherein the second distance is less than the first distance, wherein the first region is provided between the rear portion and the second region, and wherein a slope is formed between the first region and the second region, and wherein the slope transitions from the first region downward into the second region.

In embodiments, the present disclosure describes a child restraint system comprising a seat and a headrest. The child restraint system also comprises a rear portion, a first sidewall, and a second sidewall. The headrest further comprises a first region and a second region, wherein the first region is provided between the second region and the rear portion, wherein the first region comprises a first material of a first firmness, wherein the second region comprises a second material of a second firmness, wherein the first firmness is greater than the second firmness, and wherein a transition between the first firmness and the second firmness causes a motion of a vehicle occupant to be directed from the first region and into the second region during an impact event.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a front view of a headrest of a child restraint system.

FIG. 1B is a top-down view of the headrest of the child restraint system of FIG. 1A.

FIG. 1C is a cross-section of a top-down view of the headrest of the child restraint system of FIG. 1A.

FIG. 2A is a front view of a headrest of another child restraint system.

FIG. 2B is a top-down view of the headrest of the child restraint system of FIG. 2A.

FIG. 2C is a side view of a left side of the headrest of the child restraint system of FIG. 2A.

FIG. 2D is a cross-section of a top-down view of the headrest of the child restraint system of FIG. 2A.

FIG. 3 is a front view of a left side of the headrest of the child restraint system of FIG. 2A.

FIG. 4 is a cross-section of a front view of a right side of another headrest of a child restraint system.

FIG. 5 is another cross-section of a front view of a right side of another headrest of a child restraint system.

FIG. 6 is another front view of a left side of the headrest of the child restraint system of FIG. 2A.

FIG. 7 is another cross-section view of a headrest of a child restraint system.

FIG. 8 is a perspective cross-section view of another headrest of a child restraint system.

FIG. 9 is a rear view of a right side of the headrest of a child restraint system of FIG. 8.

FIG. 10 is a perspective view of another headrest of a child restraint system.

FIG. 11 is a front view of a headrest of another child restraint system.

The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

Child restraint systems may be different types of seats that are used to secure children (or other passengers) within moving bodies, such as vehicles. A child restraint system may include a headrest used to support a head of the child (or any other type of vehicle occupant) and also protect the child from injury during a crash event of the vehicle. In embodiments, the headrest may be a separate apparatus that is removably inserted into the seat of the child restraint system. However, in other embodiments, the headrest may be permanently coupled to the seat of the child restraint system as well.

In embodiments, the headrest of the child restraint system may include a rear portion and one or more side walls that extend outwardly from the rear portion. That is, when the child restraint system is provided within a vehicle and the child is seated in the child restraint system, the rear portion of the headrest is located behind the head of the child and the one or more sidewalls are located on either side of the head of the child. For example, the one or more sidewalls may include a left sidewall that is located to the left of the head of the child and a right sidewall that is located to the right of the head of the child.

In embodiments, each of the one or more sidewalls may include protruding material that provides a physical buffer between the child (e.g., a head of the child) and the door or other type of vehicle structure. For example, the material provided at the one or more sidewalls may include one or more foam materials, such as expanded polystyrene (EPS), Expanded Polypropylene (EPP), Expanded polyethylene (EPE), urethane, and/or a blend of any of these types of foams. The material may also include materials other than foam as well.

When a side crash event occurs with the vehicle, the child may first contact one of the side walls of the child restraint system instead of directly contacting the door or other vehicle structure as a result of the force of the side crash event. However, oftentimes these side walls only include an air bladder or other type of compressible material and are substantially parallel with a door or other type of vehicle structure when the child restraint system is provided in the vehicle. Thus, when the side crash event occurs, energy dissipation may occur rapidly as the child comes into contact with the side wall. That is, the sidewall in these types of child restraint systems may compress through the depth of the material to slow the momentum of the child into the door or other structure of the vehicle during the crash event. This may result in a large energy transfer in a short time period.

The present disclosure describes a child restraint system that provides for energy transfer over an extended period of time compared to these existing child restraint systems. This child restraint system described herein has sidewalls that include two regions of material (a first region and a second region, where the first region is located between the rear portion of the headrest and the second region). The two regions of material may protrude from the child restraint system at different distances and different angles. For example, the first region may protrude a first distance from a sidewall and the second region may protrude a second distance from the sidewall. In embodiments, the second distance is shorter than the first distance. Additionally, a slope in the material may be formed between the first region and the second region (the slope may be formed as a part of the first region and/or the second region as well).

In this manner, during the side crash event, the child first comes into contact with the first region of the side wall and travels across the first region and downwards into the second region of the sidewall. As such, the time period during which the energy transfer occurs is extended as the motion of the child is directed along the surface of the side wall rather than the energy transfer occurring as the child compresses the material of the side wall. That is, the geometry of the child restraint system as described herein redirects the motion of the child to allow the child to “roll” across the side wall rather than the child coming to a sudden stop through rapid deceleration resulting from the compression of the material of the sidewall in a conventional child restraint system.

The child restraint system as described herein may also be configured to direct the momentum of the child along the surface of the sidewall in other ways as well. For example, rather than including two regions that protrude from a given sidewall at different distances, a headrest may also include two regions that protrude from the sidewall the same distance but are of different firmness. The firmness of a region may be a factor of how easily the material forming the region deforms when the child comes into contact with the material (e.g., a harder versus a softer material).

A first region may be provided at a first firmness and a second region may be provided at a second firmness that is less than the first firmness. In such embodiments, the first region may still be provided in between the second region and the rear portion of the headrest. When a side impact event occurs within a vehicle, the head of the child may come into contact with the first region and the second region. The transition between the firmer first region and the softer second region may direct the momentum of the head of the head of the child across the first region and into the second region as the second region compresses further into the sidewall than the first region.

Additionally, a sidewall is not necessarily limited to only two distinct regions. For example, a sidewall may include three, four, five, or any other number of regions. Each region may protrude from the sidewall at different distances, may be of varying degrees of firmness, etc. In some instances, some of the regions may protrude the same distance from the sidewall, be of the same firmness, etc.

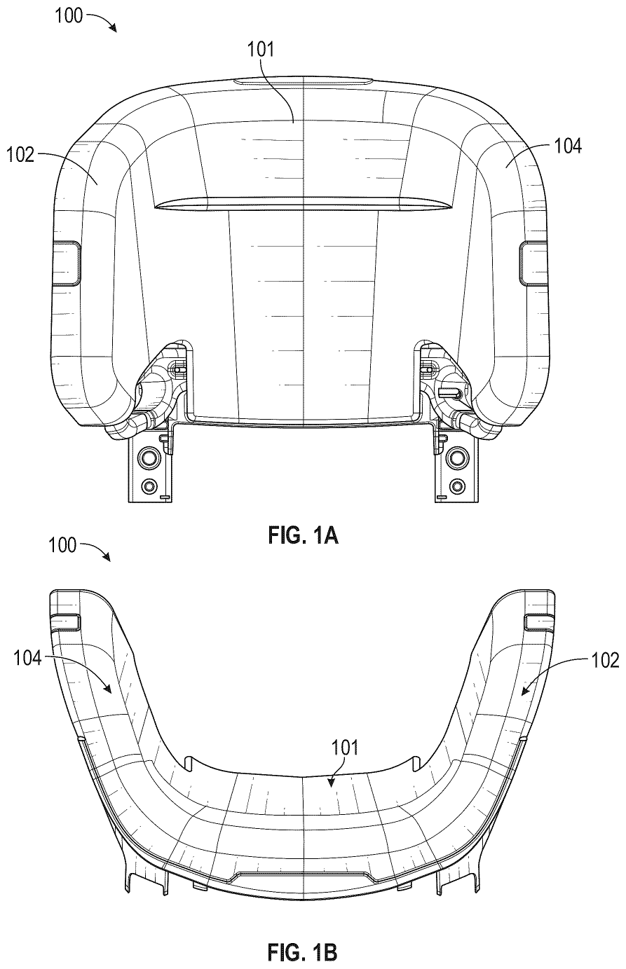

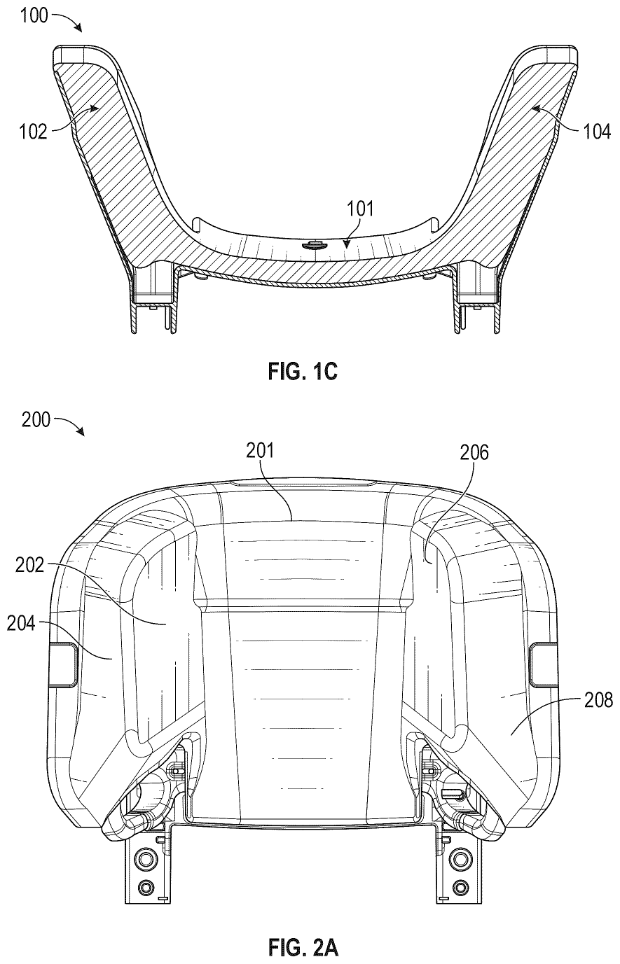

FIG. 1A is a front view of a headrest 100 of a child restraint system. FIG. 1B is a top-down view of the headrest 100 of the child restraint system of FIG. 1A. FIG. 1C is a cross-section of a top-down view of the headrest 100 of the child restraint system of FIG. 1A. The headrest 100 includes a rear portion 101 and one or more sidewalls (for example, a first sidewall 102 and a second sidewall 104). The first sidewall 102 and the second sidewall 104 may provide energy dissipation as the head of a child accelerates toward a door or other structure of a vehicle during a side crash event. That is, the head of the child first comes into contact with the first sidewall 102 or the second sidewall 104 of the headrest 100 rather than coming into direct contact with the door or other structure of the vehicle.

Depending on where the child restraint system is provided in the vehicle, either the first sidewall 102 or the second sidewall 104 may be positioned at least substantially parallel with the door or other structure of the vehicle. For example, if the child restraint system is provided on a seat by a left-hand seat of the vehicle (from the perspective of the child seated in the child restraint system), then the second sidewall 104 may be positioned at least substantially in parallel with the left-hand door of the vehicle. In this example, during a side crash event, the second sidewall 104 may provide for energy dissipation as the head of the child accelerates towards the left-hand door of the vehicle.

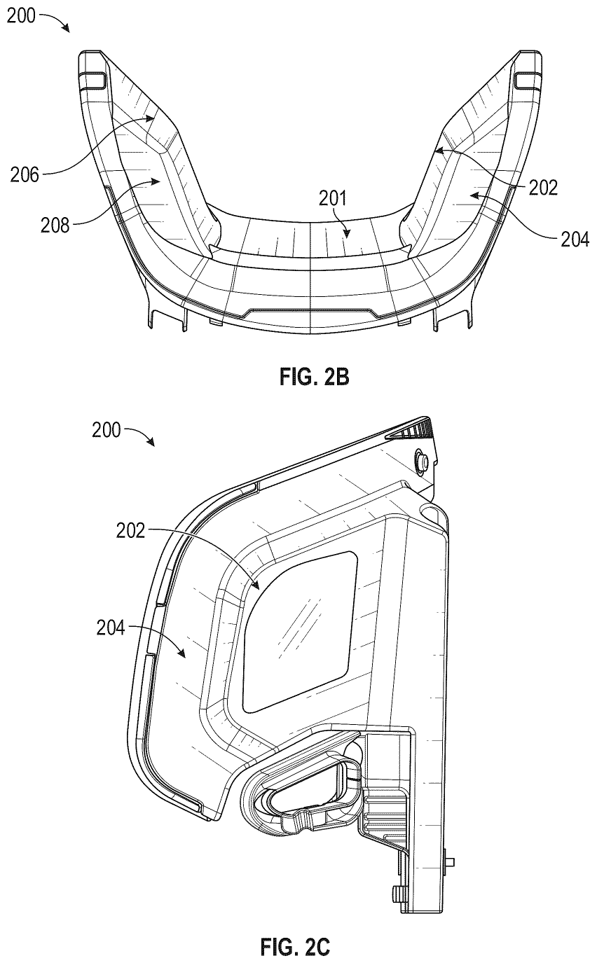

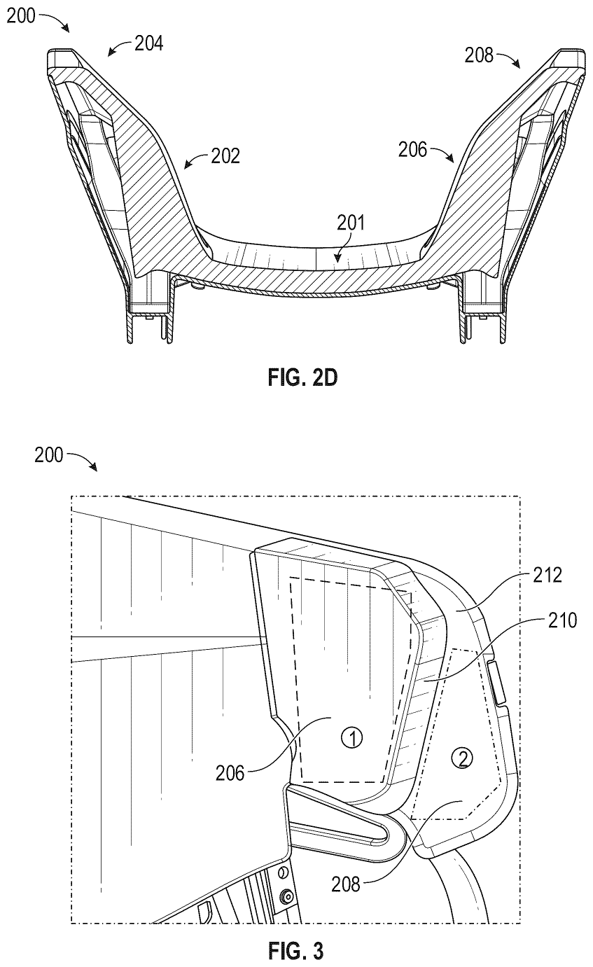

FIG. 2A is a front view of a headrest 200 of another child restraint system. FIG. 2B is a top-down view of the headrest 200 of the child restraint system of FIG. 2A. Similar to the headrest 100, the headrest 200 includes a rear portion 201 and one or more sidewalls. However, in contrast with the headrest 100, the sidewalls of the headrest 200 each include two regions. For example, a first sidewall includes a first region 202 and a second region 204 and a second sidewall includes a first region 206 and a second region 208.

In embodiments, the two regions of each of the sidewalls may protrude from the headrest at different distances. For example, the first region 202 of the first sidewall and the first region 206 of the second sidewall may protrude from the headrest 200 at a first distance. The second region 204 of the first sidewall and the second region 208 of the second sidewall may protrude from the headrest at a second distance. The first distance may be greater than the second distance such that the first region 202 of the first sidewall and first region 206 of the second sidewall protrude from the headrest 200 at a greater distance than the second region 204 of the first sidewall and the second region 208 of the second sidewall.

In embodiments, the second region 204 of the first sidewall and the second region 208 of the second sidewall may also be provided at an angle such that they slope away from the first region 202 of the first sidewall and the first region 206 of the second sidewall. In further embodiments, the angled surface may be included in the first region 202 (and/or the first region 206) and may slope downwards into the second region 204 (and/or the second region 204). An illustration of this embodiment is shown in FIG. 2C.

This geometrical configuration of the first and second regions of the respective sidewalls directs the motion of a head of a child seated in the child restraint system across the surface of the first region and into the second region during a side crash event of a vehicle in which the child restraint system is provided. This allows for energy dissipation to be performed along a greater distance in the headrest 200 as the head travels along the surface of the sidewalls rather than only traveling the distance required to compress the material of the sidewall in the headrest 100 shown in FIGS. 1A-1C. For example, if the force of a side crash event were to direct a child in the child restraint system towards the left-hand side of the headrest 200 (from the perspective of the seated child), then the head of the child would first come into contact with the first region 206 of the second sidewall. The motion of the head would then be directed across the first region 206, down the sloped angle, and into the second region 208 of the second sidewall. Similar energy dissipation may be provided across the first region 202 and the second region 204 of the first sidewall as well.

FIG. 2D is a cross-section of a top-down view of the headrest 200 of the child restraint system of FIG. 2A.

The two regions of each of the sidewalls may be formed using the same or different materials. As a non-limiting example, the two regions may be formed using one or more foam materials, such as expanded polystyrene (EPS), Expanded Polypropylene (EPP), Expanded polyethylene (EPE), urethane, and/or a blend of any of these types of foams. The two regions may also be formed using any other material other than foam as well.

In embodiments, the material forming the first region and the second region may be the same type of material or a different type of material. That is, for example, the first region may include a first type of foam and the second region may include a second type of foam. Alternatively, both the first region and the second region may include the first type of foam.

In embodiments, the first region and second region of a given sidewall may be formed by providing varying amounts of foam to each region. For example, a greater amount of foam may be provided in the first region of the sidewall than the second region of the sidewall such that the first region protrudes from the headrest a greater distance than the second region.

A firmness of the first region may also differ from a firmness of the second region. For example, the first region may be provided with a greater firmness than the second region. In this manner, the momentum of the head may be more effectively directed down the firmer first region into a softer second region as the head causes the first region to deform to a lesser extent than the second region.

The firmness differential between the first region and the second region may be accomplished in a number of different ways. As a first example, the firmness of the first region may be greater by using a firmer material within the first region than the second region. For example, a firmer type of foam (or other material) may be provided in the first region and a softer type of foam (or other material) may be provided in the second region. As a second example, the firmness of the first region may be greater by using a solid material in the first region and a hollow material (such as a hollow foam) in the second region. As a third example, the first region and the second region may include the same type of material, but the firmness of the first region may be increased by providing additional supporting structure within the first region. For example, the additional structure may include ribbing elements provided within the first region. FIG. 11 shows a headrest 1100 including example ribbing elements 1102 provided on a sidewall 1104 of the headrest 1100. The additional structure is not limited to ribbing elements 1102 and may also include additional structure of any other shape and/or size or combination of different types of shapes and/or sizes.

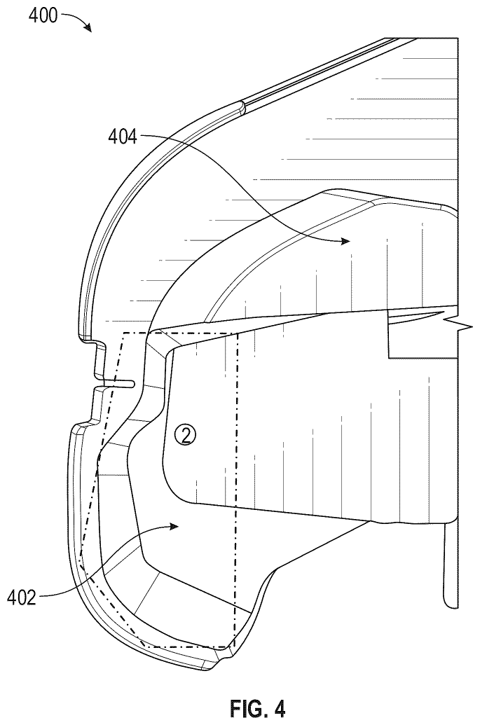

FIG. 3 is a front view of a left side (from the perspective of a child seated in the child restraint system) of the headrest 200 of the child restraint system of FIG. 2A. FIG. 3 shows an example configuration of the material that is provided in the first region 206 and the second region 208 to create the sidewall 212 at the right side of the headrest 200. The material in the first region 206 is shown as protruding from the sidewall 212 a first distance. The material in the second region 208 is shown as protruding from the sidewall 212 a second distance, with the first distance being greater than the second distance.

In embodiments, a slope 210 is provided between the first region 206 and the second region 208. The slope 210 may be formed as a part of the first region 206 and/or second region 208. The slope 210 transitions from the first region 206 and downwards into the second region 208. In this manner, the head of the child may first come into contact with the material of the first region 206, travel down the slope 210, and eventually come into contact with the second region 208. Thus, the head of the child travels down the sidewall 212 during a crash event and the time during which energy dissipation occurs is extended.

The slope 210 provided between the first region 206 and the second region 208 (or formed as a part of the first region 206 and/or second region 208) may be provided at any angle between the first region 206 and the second region 208. That is, the slope 210 may be provided at a greater angle to provide a longer surface along which the head may travel or a lesser distance to reduce the vertical distance towards the sidewall 212 that the head travels during the crash event.

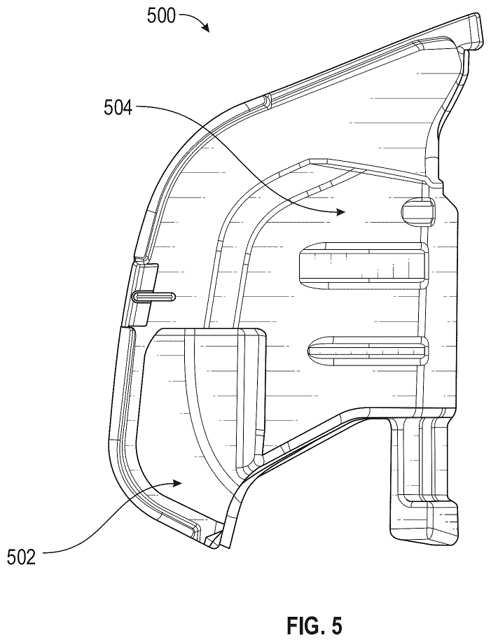

Additionally, while specific shapes and/or sizes of the material forming the first region 206 and/or second region 208 are shown, these are not intended to be limiting. The material of the first region 206 and/or second region 208 may also form any other shapes and/or sizes (and may protrude from the sidewall 212 at any combination of distances. In some instances, the shapes and/or sizes of the material may depend on the type of child restraint system. For example, a first combination of shapes and/or sizes may be provided for a first child restraint system that is intended for larger children and a second combination of shapes and/or sizes may be provided for a second child restraint system that is intended for smaller children. For example, further embodiments are shown in FIGS. 5-10.

FIG. 4 is a cross-section of a front view of a right side (from the perspective of a child seated in the child restraint system) of another headrest 400 of a child restraint system. The headrest 400 includes a first region 404 and a second region 402. FIG. 4 illustrates an alternative to a headrest including a second region with material that simply protrudes from the right sidewall a shorter distance than the material of the first region. In this alternative, the second region 402 is provided as a void (for example, a lack of material protruding from the left sidewall of the headrest 400). This alternative embodiment, similar to other embodiments described herein, also provides a geometry that causes the head of the child to roll across the first region and down into the second region during a crash event rather than the head of the child simply traveling into a sidewall of the headrest and compressing the material of the sidewall.

FIG. 5 is another cross-section of a front view of a right side (from the perspective of a child seated in the child restraint system) of another headrest 500 of a child restraint system including a first region 504 and a second region 502.

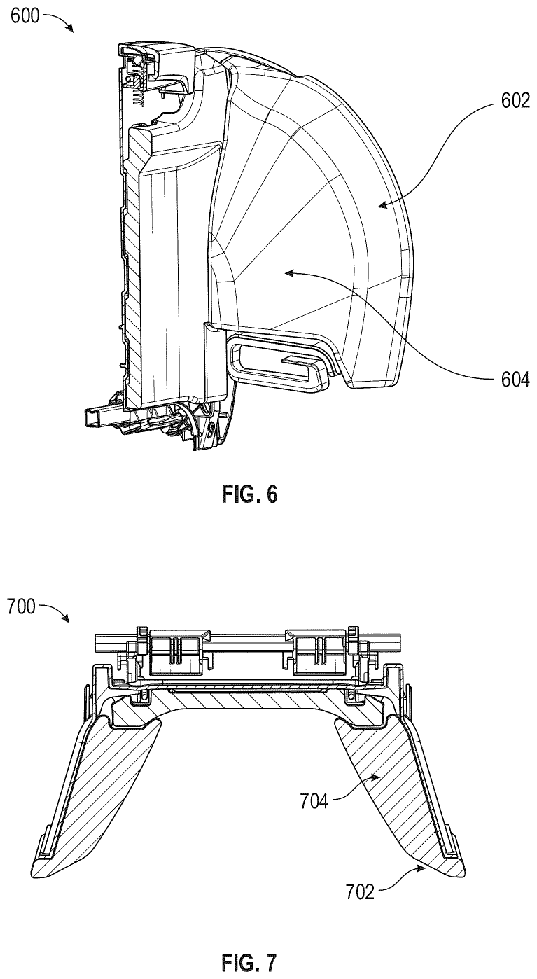

FIG. 6 is another front view of a left side of the headrest of the child restraint system of FIG. 2A. FIG. 6 shows the first region 604 and the second region 602.

FIG. 7 is another cross-section view of a headrest 700 of a child restraint system including a first region 704 and a second region 702.

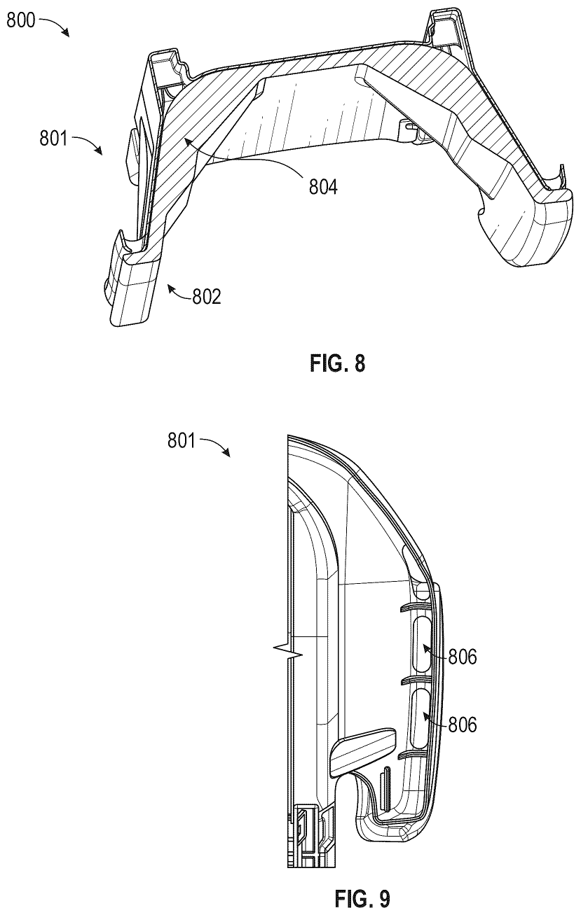

FIG. 8 is a perspective cross-section view of another headrest 800 of a child restraint system including a first region 804 and a second region 802.

FIG. 9 is a rear view of a right side of the headrest of a child restraint system of FIG. 8. FIG. 9 shows that the material forming the second region may be secured to the sidewall 801 through one or more apertures 806. However, the material may be secured to the sidewall 801 through any other suitable mechanism, such as an adhesive, etc.

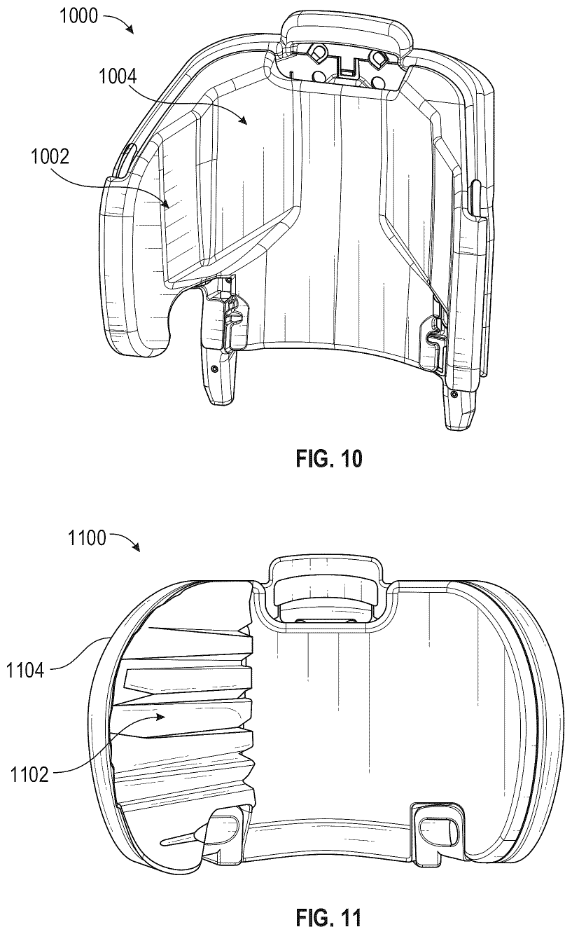

FIG. 10 is a perspective view of another headrest 1000 of a child restraint system including a first region 1004 and a second region 1002.

Though the disclosed examples include particular arrangements of a number of parts, components, features, and aspects, the disclosure is not limited to only those examples or arrangements shown. Any one or more of the parts, components, features, and aspects of the disclosure may be employed alone or in other arrangements of any two or more of the same.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single element, but the corresponding description should be read to include embodiments of two or more elements. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A child restraint system comprising:
a seat; and
a headrest comprising a rear portion, a first sidewall, and a second sidewall, wherein the headrest further comprises:
a first region protruding a first distance from the first sidewall; and
a second region protruding a second distance from the first sidewall, wherein the second distance is less than the first distance, wherein the first region is provided between the rear portion and the second region, and wherein a slope is formed between the first region and the second region, and wherein the slope transitions from the first region downward into the second region.

2. The child restraint system of claim 1, wherein the first region comprises a first material of a first firmness, wherein the second region comprises a second material of a second firmness, and wherein the first firmness is greater than the second firmness.

3. The child restraint system of claim 2, wherein the first material and second material are a same type of material.

4. The child restraint system of claim 2, wherein the first material and second material are a different type of material.

5. The child restraint system of claim 1, wherein the first region comprises a solid material and the second region comprises a hollow material.

6. The child restraint system of claim 1, wherein the second region comprises a void.

7. The child restraint system of claim 1, wherein one or more ribbing elements are disposed within a material of the first region to provide additional rigidity to the first region.

8. The child restraint system of claim 1, wherein the first region and second region comprise at least one of: expanded polystyrene (EPS), Expanded Polypropylene (EPP), Expanded polyethylene (EPE), and urethane foam.

9. A headrest for a child restraint system comprising:
a rear portion; and
a first sidewall and a second sidewall, wherein the headrest further comprises:
a first region protruding a first distance from the first sidewall; and
a second region protruding a second distance from the first sidewall, wherein the second distance is less than the first distance, wherein the first region is provided between the rear portion and the second region, and wherein a slope is formed between the first region and the second region, and wherein the slope transitions from the first region downward into the second region.

10. The headrest of claim 9, wherein the first region comprises a first material of a first firmness, wherein the second region comprises a second material of a second firmness, and wherein the first firmness is greater than the second firmness.

11. The headrest of claim 10, wherein the first material and second material are a same type of material.

12. The child restraint system of claim 10, wherein the first material and second material are a different type of material.

13. The headrest of claim 10, wherein the first region comprises a solid material and the second region comprises a hollow material.

14. The headrest of claim 10, wherein the second region comprises a void.

15. The headrest of claim 10, wherein one or more ribbing elements are disposed within a material of the first region to provide additional rigidity to the first region.

16. The headrest of claim 10, wherein the first region and second region comprise at least one of: expanded polystyrene (EPS), Expanded Polypropylene (EPP), Expanded polyethylene (EPE), and urethane foam.

17. A child restraint system comprising:
a seat; and
a headrest comprising a rear portion, a first sidewall, and a second sidewall, wherein the headrest further comprises:
a first region; and
a second region, wherein the first region is provided between the second region and the rear portion, wherein the first region comprises a first material of a first firmness, wherein the second region comprises a second material of a second firmness, wherein the first firmness is greater than the second firmness, and wherein a transition between the first firmness and the second firmness causes a motion of a vehicle occupant to be directed from the first region and into the second region during an impact event.

18. The child restraint system of claim 17, wherein the first region comprises a solid material and the second region comprises a hollow material.

19. The child restraint system of claim 17, wherein one or more ribbing elements are disposed within a material of the first region to provide additional rigidity to the first region.

20. The child restraint system of claim 7, wherein the first region and second region comprise at least one of: expanded polystyrene (EPS), Expanded Polypropylene (EPP), Expanded polyethylene (EPE), and urethane foam.
